(19) United States
(12) Patent Application Publication
(10) Pub. No.: US 2008/0234433 A1
(43) Pub. Date: Sep. 25, 2008

(54) CATALYZED MULTIPLE GRAFTING POLYMERIZATIONS

(76) Inventor: Alexandru Dragos Asandei, Vernon, CT (US)

Correspondence Address: CANTOR COLBURN, LLP, 20 Church Street, 22nd Floor, Hartford, CT, 06103, US

(21) Appl. No.: 12/052,947

(22) Filed: Mar. 21, 2008

Related U.S. Application Data
(60) Provisional application No. 60/896,609, filed on Mar. 23, 2007.

(51) Int. Cl. C08L 37/00

(52) U.S. Cl. 525/74; 525/403

(57) ABSTRACT

Methods of preparing a graft copolymer comprising a plurality of different grafts wherein the methods employ an epoxide macroinitiator and an early transition metal radical ring opening catalyst without the need for any epoxide protection/deprotection steps. Such a process results in graft copolymers having complex polymer architectures.

### CROSS-REFERENCE TO RELATED APPLICATIONS

This application claims priority to Provisional Application No. 60/896,609 filed Mar. 23, 2007, the entire contents of which are hereby incorporated by reference.

### STATEMENT REGARDING FEDERALLY SPONSORED RESEARCH

The U.S. Government has certain rights in this invention pursuant to National Science Foundation Grant No. CHEM0518247.

### TECHNICAL FIELD

This invention relates to a new method for the preparation of graft copolymers with multiple types of side arms, the graft copolymers formed, and applications utilizing the formed graft copolymers.

### BACKGROUND

Graft copolymers contain side-chain branches emanating from different points along the polymer backbone. Variations in the nature of the main chain and side chains, in the length and polydispersity of the backbone and branches as well as in graft density determine the properties of the resulting graft copolymer. These variables also relate to the synthetic complexity of preparing these copolymers.

Graft copolymers can generally be prepared by the “onto”, “through” and “from” grafting processes. In the “grafting onto” process, end-functionalized polymer chains are attached to the main chain of another polymer by coupling reactions with functional groups along its backbone. This process has its drawbacks, however, as is provides poor control over the quantitative coupling.

The “grafting through” process is based on the synthesis of a well-defined macromonomer, followed by its copolymerization with a low molecular weight comonomer. Although control over length and polydispersity can be achieved for both backbone and side chains, the main drawback of this approach is the tedious multistep synthesis required and the fact that the grafting density is limited by the reactivity ratios of the macromonomers. Therefore, steric hindrance may prohibit the synthesis of dense brush copolymers.

The “grafting from” process is based on the synthesis of a macroinitiator containing suitable initiating groups along the backbone. The high initiator efficiency, the ability to manipulate initiator distribution along the main chain and the side chain length control afforded by living polymerization techniques makes the “grafting from” process an attractive option in the synthesis of well defined graft copolymers. The multiple advantages of the living radical polymerization (LRP) consist in its ability to control molecular weight and polydispersity as well as water tolerance, as opposed to ionic and coordination living polymerizations.

Typical LRP initiators for metal catalyzed polymerizations are based either on redox processes involving late transition metal complexes and activated alkyl halides or on thermal systems. The molecular weight (Mₙ) and polydispersity (M_{w}/Mₙ) control in LRP is afforded by the reversible termination of growing chains with persistent radicals or degenerative transfer (DT) agents and proceeds mechanistically via either atom transfer (ATRP), dissociation-combination (DC) or degenerative transfer (DT) processes. Thus, living grafting copolymerization by ATRP via the “grafting from” method requires the presence of activated halides along the polymer backbone. Consequently, the main chain cannot be synthesized directly in a controlled fashion via ATRP, unless the halide is masked at the expense of the increase in the number of synthetic steps.

Therefore, there remains a need in the art for improved varieties of ATRP-compatible initiator functionalities. There further remains a continuing need in the art for more convenient methods to prepare graft copolymers, specifically mixed arm graft copolymers. There also remains a need in the art for new graft copolymers with complex architectures and compositions which can be prepared conveniently and economically.

### BRIEF SUMMARY OF THE INVENTION

In one embodiment, a method of preparing a graft copolymer, comprises reacting a first grafting monomer with an epoxide macroinitiator in the presence of an early transition metal radical ring opening catalyst to form a first graft copolymer, wherein the first graft copolymer comprises epoxide groups; reacting the first graft copolymer with a second grafting monomer in the presence of an early transition metal radical ring opening catalyst to form a second graft copolymer comprising two different grafts. The process can be repeated until all epoxide groups are exhausted.

### BRIEF DESCRIPTION OF DRAWINGS

FIG. 1 is a general schematic of the synthesis of mixed arm graft copolymers.

FIG. 2 is a graph illustrating the dependence of Mₙ and M_{w}/Mₙ on conversion in the CuBr₂-mediated graft copolymerization of methyl methacrylate (▴ and GPC inset) and styrene (▪) from PGMA initiated by Cp₂TiCl-catalyzed epoxide radical ring opening.

FIG. 3 is a graph illustrating selected DSC traces of PGMA, PGMA-g-PSt, PGMA-g-PMMA, and PGMA-g-PBMA.

FIG. 4 is a graph illustrating selected DSC traces of PGMA-co-PMMA, (PGMA-co-PMMA)-g-PSt, (PGMA-co-PMMA)-g-PBA, PGMA-co-PSt, and (PGMA-co-PSt)-g-PMMA.

FIG. 5 is a graph illustrating selected DSC traces of PGMA, PGMA-g-PMMA, (PGMA-g-PMMA)-g-PSt, PGMA-g-PSt, (PGMA-g-PSt)-g-PMMA, and ((PGMA-g-PMMA)-g-PSt)-g-PBMA.

FIG. 6 is a general schematic of the synthesis of (PGMA-co-PMMA)-g-PCL.

### DETAILED DESCRIPTION OF THE INVENTION

A convenient synthesis for the preparation of graft copolymers having multiple types of side arms is disclosed using epoxides in radical grafting copolymerizations. The synthesis involves the early transition metal-catalyzed radical ring opening of the epoxide group of ethylenically unsaturated compounds without the need for any epoxide protection/deprotection steps. The synthesis allows for the convenient preparation of mixed arm graft copolymers having a wide range of molecular weights and complex compositions as the grafting can be performed in an iterative manner.

The grafting is provided using a radical ring opening reaction of epoxide groups of an epoxide macroinitiator mediated by an early transition metal catalyst, which in turn allows for the early transition metal catalyzed living radical polymerization of grafting monomers comprising ethylenically unsaturated groups. The living grafting process allows for the control of the polymer architecture, including graft length, graft density and molecular weight. Specifically, the living process allows for the formation of graft copolymers that exhibit low polydispersity.

In one embodiment, the graft copolymers comprising two or more grafts can be prepared by reacting an epoxide macroinitiator, e.g. a polymer comprising epoxide groups, with a first grafting monomer in the presence of an early transition metal catalyst to form a first graft copolymer which comprises an amount of epoxide groups less than the original epoxide macroinitiator. The grafting is provided using a radical ring opening reaction. The first graft copolymer can then be further reacted with a second grafting monomer in the presence of the early transition metal catalyst to form a second graft copolymer comprising two different grafts. Depending upon the ratio and amount of first/second graft polymer and early transition metal catalyst, the second graft copolymer can either comprise no further epoxide groups available for further grafting, or it can comprise a portion of remaining epoxide groups capable of undergoing further radical ring opening processes to result in yet another graft copolymer comprising three, four, five, six, seven, eight, nine, ten, or more different grafts.

An epoxide macroinitiator is generally a polymer comprising pendent or main chain epoxide groups available as functional groups for the grafting of a variety of ethylenically unsaturated and cyclic grafting monomers via radical ring opening reaction processes. The epoxide macroinitiator is specifically a linear homopolymer or copolymer. In one embodiment, the epoxide macroinitiator is poly(glycidyl acrylate), poly(glycidyl methacrylate), copolymers thereof, and the like.

In one embodiment, the epoxide macroinitiator can be prepared by polymerizing a macroinitiator monomer comprising both an ethylenically unsaturated group and an epoxide group. An exemplary macroinitiator monomer is one that meets the general structure G-Z-E, wherein G is an ethylenically unsaturated group, Z is a linking group and E is an epoxide group. Exemplary G groups include acrylate (CH₂═CH—(C═O)O—); thioacrylate (CH₂═CH—(C═O)S—); C₁-C₄ alkyl(acrylate) (e.g., methacrylate (CH₂═C(Me)-(C═O)O—), ethylacrylate, etc.); C₁-C₄ thioalkyl(acrylate); vinyl; methylvinyl; fluorovinyl; allyl; acrylamide; C₁-C₄ alkyl(acrylamide); and the like groups.

The Z linking group can be a divalent C₁-C₆ alkyl, C₁-C₆ alkyl, aryl, C₁-C₆ alkylaryl, aryl(C₁-C₆)alkyl, or C₁-C₆ alkylaryl(C₁-C₆)allyl, wherein the Z linking group may be optionally substituted by one or more fluorine groups up to and including perfluorinated substitution.

Specific macroinitiator monomers include glycidyl acrylate, glycidyl methacrylate, glycidyl acrylamide, glycidyl methacrylamide, 1,2-epoxy-p-menth-8-ene (limonene oxide), 4-vinyl-1-cyclohexene 1,2-epoxide, and the like.

Optionally, the macroinitiator monomer can be polymerized in the presence of an additional monomer comprising an ethylenically unsaturated group to result in an epoxide macroinitiator which is a copolymer. Copolymerization dilutes the epoxide content and provides additional means of controlling graft density in the final graft copolymer. Exemplary additional monomers include those that meet the general structure G¹-R^{a}, wherein G¹ is an ethylenically unsaturated group, that is acrylate (CH₂═CH—(C═O)O—); thioacrylate (CH₂═CH—(C═O)S—); C₁-C₄ alkyl(acrylate) (e.g., methacrylate (CH₂═C(Me)-(C═O)O—), ethylacrylate, etc.); C₁-C₄ thioalkyl(acrylate); vinyl; methylvinyl; allyl; acrylamide; C₁-C₄ alkyl(acrylamide); and the like groups; and R^{a} is C₁-C₆ alkyl; aryl; —C₁-C₆ alkylaryl; -aryl(C₁-C₆)alkyl; —C₁-C₆ alkylaryl(C₁-C₆)alkyl; halogen (fluoro, chloro, etc.); alkylester (—O(C═O)C₁-C₆ alkyl); —CH═CH₂; and the like.

Exemplary additional monomers include methyl acrylate, methyl methacrylate, ethyl acrylate, ethyl methacrylate, n-propyl acrylate, n-propyl methacrylate, isopropyl acrylate, isopropyl methacylate, n-butyl acrylate, n-butyl methacrylate, iso-butyl acrylate, iso-butyl methacrylate, tert-butyl acrylate, tert-butyl methacrylate, benzyl acrylate, benzyl methacrylate, phenyl acrylate, phenyl methacrylate, styrene, alpha-methylstyrene, vinyltoluene, ethylvinylbenzene, acrylonitrile, vinyl acetate, a vinyl ester, vinyl chloride, vinyl fluoride, vinylidene fluoride, isoprene, butadiene, and the like.

In one embodiment, the epoxide macroinitiator polymer can be prepared using a catalyst and an initiator for atom transfer radical polymerization. Exemplary catalyst systems include copper halide or oxides in combination with a ligand such as 2,2′-bipyridyl (bpy), specifically CuCl/bpy or CuBr/bpy. Exemplary initiators include alkylsulfonyl halides, arylsulfonyl halides, and alkyl halides; specifically 4-methoxybenzenesulfonyl chloride, ethyl 2-bromoisobutyrate, p-toluenesulfonyl chloride, methanesulfonyl chloride, trichloromethanesulfonyl chloride, and the like.

In another embodiment, the epoxide macroinitiator is prepared by conventional free radical polymerization methods using a thermal initiator. Suitable thermal initiators include peroxy initiators or azo derivatives. Exemplary peroxy initiators include, for example, benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha,alpha′-bis(t-butylperoxy-m-isopropyl)benzene, 2,5-dimethyl-2,5-di(t-butylperoxy)hexane, dicumylperoxide, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and combinations comprising at least one of the foregoing thermal initiators.

The formation of the epoxide macroinitiator can be performed in the presence or the absence of a solvent. Exemplary solvents include those that do not adversely affect the reaction, and are preferably inert. Suitable solvents are further selected on the basis of economics, environmental factors, and the like. Suitable organic solvents may be aromatic hydrocarbons such as toluene, xylene, anisole, etc.; aliphatic hydrocarbons such as hexane; ethers such as tetrahydrofuran, dioxolane, 1,4-dioxane, diphenylether, etc.; and the like, as well as mixtures comprising at least one of the foregoing organic solvents. Aqueous solvents may also be used including water optionally in combination with water-miscible organic liquids such as lower alcohols, acetonitrile, tetrahydrofuran, dimethylacetamide, dimethyl formamide, and the like. The polymerization may be carried out in an aqueous emulsion or suspension.

The epoxide macroinitiator can be prepared under inert conditions. An inert atmosphere, free or essentially free of molecular oxygen, can be used. Exemplary inert gasses include nitrogen, argon, etc.

The polymerization process for preparing the epoxide macroinitiator using atom transfer radical polymerization may be performed at a temperature of about 0° C. to about 150° C., specifically at a temperature of about 20° C. to about 130° C., more specifically at about 60° C. to about 90° C. The epoxide macroinitiator can be prepared to form random, block or gradient copolymers depending on the reactivity ratios of the monomers. The time for the reaction may be about 10 minutes to about 24 hours, specifically about 1 hour to about 12 hours, and more specifically about 4 hours to about 8 hours.

The epoxide macroinitiator can be isolated using techniques known to one of ordinary skill in the art. Exemplary techniques include precipitation by the addition of a poor solvent to the reaction mixture. The resulting precipitate can be isolated by filtration and optionally dried under reduced pressure and/or elevated temperature; spray dried; or freeze-dried.

In another embodiment, the epoxide macroinitiator can be prepared by the epoxidation of unsaturated polymers containing ethylenically unsaturated groups in their main chain or side chain, for example epoxidation of poly(isoprene), poly(butadiene) or polynorbornene.

In another embodiment, the formation of carbon-carbon double bonds in a polymer can be derived from an elimination reaction performed on a commercially available polymer (e.g. dehydrofluorination of poly(vinylidene fluoride) using base-catalyzed processes well known in the art). The resulting unsaturated polymer can then be epoxidized to form an epoxide macroinitiator.

In still another embodiment, the epoxide macroinitiator can be prepared by derivatization of a polymer backbone with epichlorohydrin or a similar epoxide-containing reagent.

The grafting process involves the radical ring opening reaction of the epoxide groups of the epoxide macroinitiator in the presence of a grafting monomer. Early transition metal catalysts can be used to promote the radical ring opening reaction.

The grafting monomer can be a monomer comprising an ethylenically unsaturated group or it can be a cyclic grafting monomer such as a cyclic ester or a cyclic amide

Exemplary grafting monomers include those that meet the general structure G²-R^{b}, wherein G² is an ethylenically unsaturated group that is acrylate (CH₂═CH—(C═O)O—); thioacrylate (CH₂═CH—(C═O)S—); C₁-C₄ alkyl(acrylate) (e.g., methacrylate (CH₂═C(Me)-(C═O)O—), ethylacrylate, etc.); C₁-C₄ thioalkyl(acrylate); vinyl; allyl; acrylamide; C₁-C₄ alkyl(acrylamide); and the like groups; and R^{b} is C₁-C₆ alkyl; aryl; —C₁-C₆ alkylaryl; -aryl(C₁-C₆)alkyl; or —C₁-C₆ alkylaryl(C₁-C₆)alkyl; —Si(OC₁-C₆ alkyl)₃; halogen (fluoro, chloro, etc.); alkylester (—O(C═O)C₁-C₆ alkyl); —CH═CH₂; and the like.

Exemplary ethylenically unsaturated grafting monomers include methyl acrylate, methyl methacrylate, ethyl acrylate, ethyl methacrylate, n-propyl acrylate, n-propyl methacrylate, isopropyl acrylate, isopropyl methacylate, n-butyl acrylate, n-butyl methacrylate, iso-butyl acrylate, iso-butyl methacrylate, tert-butyl acrylate, tert-butyl methacrylate, benzyl acrylate, benzyl methacrylate, phenyl acrylate, phenyl methacrylate, styrene, vinyltoluene, ethylvinylbenzene, acrylonitrile, vinyl acetate, a vinyl ester, vinyl chloride, vinyl fluoride, vinylidene fluoride, isoprene, butadiene, and the like.

Suitable cyclic esters include, for example, C₃-C₁₂ monoesters and diesters. Specific cyclic esters that may be employed in the method include, for example, β-propiolactone, γ-butyrolactone, δ-valerolactone, ε-caprolactone, 3-methyl-1,4-dioxane-2,5-dione, 3,6-dimethyl-1,4-dioxane-2,5-dione (lactide), 1,4-dioxane-2,5-dione (glycolide), p-dioxanone, and mixtures thereof. In some embodiments, the cyclic ester is ε-caprolactone. Suitable cyclic amides include, for example, C₃-C₁₂ monoamides and diamides.

Specific cyclic amides that may be employed in the method include, for example, 2-azacyclopentanone, 2-azacyclohexanone, ε-caprolactam, 2-azacyclooctanone, 2-azacyclononanone, N-acylated derivatives of the foregoing (e.g., N-acetyl-caprolactam (1-acetylazepan-2-one)), and mixtures thereof. In some embodiments, the cyclic amide is ε-caprolactam.

In one embodiment, the grafting can be performed using a combination of an ethylenically unsaturated grafting monomer and a cyclic grafting monomer.

The amount of grafting monomer used can be an amount to react with all or substantially all of the available epoxide groups on the epoxide macroinitiator. Alternatively, if less than the full number of epoxide groups on the epoxide macroinitiator were reacted to form a graft copolymer, the resulting graft copolymer comprising remaining epoxide groups can be further reacted with additional grafting monomer(s) to form a final graft copolymer comprising two or more different grafts.

The polymer properties are controlled by the number of different types of monomers which are grafted, the graft length (which depends on the monomer/epoxide ratio) and the number of epoxides which are opened at each iteration (which controls the grafting density). Thus, the amount of grafted polymer can be chosen to provide for a particular polymer property. One of ordinary skill in the art can determine without undue experimentation how to control the number of epoxides (mole fraction) that are opened by control of the amount of transition metal catalyst used in the grafting process. Thus, if only one type of grafting monomer is grafted, the mole fraction of the opened epoxide can be x=0.01 to 0.99. Performing additional iterations using a different grafting monomer at each iteration, the mole fraction of opened epoxides can be 0<x₁+x₂+ . . . xₙ≦1 where the various xᵢ can be selected independently. For example, three successive grafts can be performed wherein x₁=0.2, x₂=0.5 and x₃=0.1 which still leaves some epoxides unopened. However, for these xᵢ, any ratios can be chosen between the monomers allowing for the maintenance of the fraction of opened epoxides constant while varying the amount of the new grafted monomers, or the percent epoxide opening can be varied while keeping the amount of grafted monomers constant, or both can be varied. Such control over the architecture and properties of the system are thus easily achieved.

In one embodiment, the ratio of macroinitiator to first grafting monomer is about 1:98 to 98:1, specifically about 10:90 to 90:10, more specifically about 25:75 to 75:25, and yet more specifically about 35:65 to 65:35.

In another embodiment, the ratio of macroinitiator to first and second grafting monomers is about 1-97:1-97:1-97. In yet another embodiment, the ratio of macroinitiator to first, second, and third grafting monomers is about 1-96:1-96:1-96:1-96.

A radical ring opening catalyst is used to initiate the radical ring opening of the epoxide groups pendant from, or on the main chain of, the epoxide macroinitiator. Exemplary catalysts include an early transition metal (M) catalyst such as titanium(III) (Ti), zirconium(III) (Zr), hafnium(III) (Hf), or chromium(III) (Cr) complexes, including sandwich metallocenes, alkoxide, and half-sandwich ligands. In one embodiment, the ring opening catalyst is L₂M(III)Y, wherein L is a ligand and Y is a halogen (fluoro, chloro, bromo, iodo). The ligand can be cyclopentadienyl; alkylsubstituted cyclopentadienyl substituted with one or more C₁-C₄ alkyl groups; indenyl; C₁-C₄ alkoxy groups; ansa ligands (e.g. ansa-bis(cyclopentadiene)); halogen; and the like, specifically cyclopentadienyl. The ring opening catalyst L₂M(III)Y can generally be prepared in situ by the reduction of the precursor L₂MYY′, wherein Y′ is a halogen. The reduction to the ring opening catalyst L₂M(III)Y can be performed using reagents and techniques known in the art, including zinc, iron, or manganese mediated reductions.

Other catalysts include precursor catalysts that can be prepared into the early transition metal(III) catalyst in situ. Exemplary precursor catalysts include early transition metal alkoxides (R⁴O)ₙM¹X¹₄₋ₙ wherein M¹ is Ti, Zr, Hf, or Cr, R⁴ is C₁-C₆ alkyl or aryl, and X¹ is halogen or C₁-C₆ alkyl.

A specific radical ring opening catalyst includes bis(cyclopentadienyl)titanium chloride (Cp₂Ti(III)Cl) which can be prepared by the reduction of bis(cyclopentadienyl)titanium dichloride (Cp₂Ti(IV)Cl₂). Bis(cyclopentadienyl)zirconium chloride (Cp₂Zr(III)Cl) can be prepared by the reduction of ZrCp₂(H)Cl. Still another catalyst is bis(cyclopentadienyl)hafnium chloride (Cp₂Hf(III)Cl).

In one embodiment, the radical ring opening catalyst is Cp₂TiCl, a mild one electron transfer agent.

The radical ring opening catalyst may be used in an amount based on the mole fraction of epoxides that is to be opened. Typically, about one mole of catalyst per mole of epoxide is sufficient. Exemplary amounts of catalyst is the mole ratio of catalyst to the epoxide such that 0.001<catalyst<10, more specifically 0.01<catalyst<5, and even more specifically 0.1<catalyst<2.0.

The grafting process can also optionally be carried out in the presence of an additional catalyst for the controlled/living polymerization of the grafting monomer which is grafted. Exemplary additional catalysts may include catalysts for atom transfer radical polymerization (ATRP) such as Cu(II) halides optionally in the presence of amine ligands; nitroxides; and RAFT (reversible addition-fragmentation catalysts (e.g., thioesters).

In one embodiment, various organic or metal centered persistent radical or degenerative transfer agents such as copper halide or oxides in combination with a ligand such as bpy, (specifically CuCl/bpy or CuBr/bpy) can be used as the additional catalyst. These catalysts are added to provide optional additional control of the grafting and prevent potential crosslinking.

Suitable solvents for conducting the grafting via radical ring opening reaction are those that do not adversely affect the reaction, and are preferably inert. Suitable solvents are further selected on the basis of economics, environmental factors, and the like. Suitable organic solvents may be aromatic hydrocarbons such as toluene, xylene, anisole, etc.; aliphatic hydrocarbons such as hexane; ethers such as tetrahydrofuran, dioxolane, 1,4-dioxane, diphenylether, perfluorinated organic solvents, etc.; and the like, as well as mixtures comprising at least one of the foregoing organic solvents. Aqueous solvents may also be used including water optionally in combination with water-miscible organic liquids such as lower alcohols, acetonitrile, tetrahydrofuran, dimethylacetamide, dimethyl formamide, and the like. The polymerization may be carried out in an aqueous emulsion or suspension.

The radical ring opening reaction may be performed at a temperature of about −78° C. to about 200° C., specifically at a temperature of about 0° C. to about 150° C., more specifically at about 60° C. to about 110° C. The time for the reaction may be about 5 minutes to about 48 hours, specifically about 1 hour to about 12 hours, and more specifically about 4 hours to about 8 hours.

An inert atmosphere, free or essentially free of molecular oxygen, is to be used when performing the radical ring opening reaction. Exemplary inert gasses include nitrogen, argon, etc.

The graft copolymer can be isolated using techniques known to one of ordinary skill in the art. Exemplary techniques include precipitation by the addition of a poor solvent to the reaction mixture. The resulting precipitate can be isolated by filtration and optionally dried under reduced pressure and/or elevated temperature; spray dried; or freeze-dried.

After reaction, the resulting graft copolymers may be purified by precipitation as is known in the art.

The graft density and length of the resulting graft copolymers can be tailored by adjusting the grafting monomer/early transition metal catalyst/epoxide ratios and from the composition of the macroinitiator polymer. The molecular weights of the graft copolymers can be controlled by choice of the ratio of grafting monomers to macroinitiator polymer and the polymer conversion (and reaction time).

Once one monomer is grafted onto the macroinitiator, the remaining unopened epoxide groups can be further used in a sequential grafting manner. Thus, by contrast to other living radical polymerization methods which would require additional synthetic steps involving the selective protection/deprotection of the main chain initiator functionality, the present methodology allows the convenient multiple, sequential and independent graft copolymerization of a series of different grafting monomers, thus providing easy access to complex polymer architectures.

In one embodiment the polydispersity (M_{w}/Mₙ) of the resulting graft copolymer is about 1.0 to about 2.5, specifically about 1.1 to about 2.0, and more specifically about 1.3 to about 1.7.

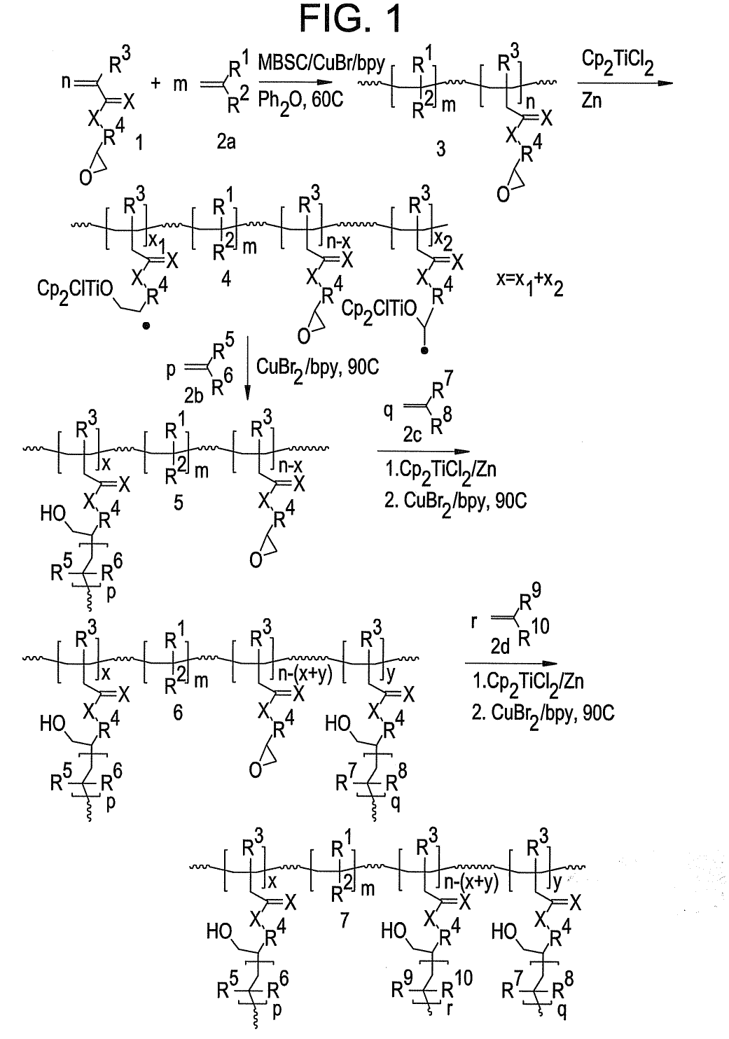

A generalized schematic of a sequential grafting process is provided in FIG. 1, which is exemplary only. An epoxide macroinitiator (3) is prepared from the reaction between a macroinitiator monomer (1) and an additional monomer (2a). The macroinitiator monomer (1) of FIG. 1 satisfies a general structure wherein each occurrence of X is independently O or S; R³ is hydrogen, halogen or C₁-C₆ alkyl; and R⁴ is C₁-C₆ alkylene or aryl group optionally substituted. An exemplary (1) is glycidyl acrylate where X is O, R³ is hydrogen, and R⁴ is methylene. The additional monomer (2a) is an ethylenically unsaturated compound wherein R¹ is hydrogen, C₁-C₆ alkyl, or halogen and R² is C₁-C₆ alkyl, aryl, C₁-C₆ alkylester or aryl. The epoxide macroinitiator (3) is then reacted with a grafting monomer (2b) in the presence of Cp₂TiCl. Not wishing to be bound by theory, but it is believed that the radical ring opening proceeds with the formation of macromolecular Ti alkoxides (Cp₂ClTi—O-macroinitiator) and of a mixture of reactive, constitutionally isomeric primary and secondary C-centered radicals derived from the regioselectivity of the radical ring opening (4). The β-titanoxy radicals have the same thermodynamic stabilization as the corresponding alkyl radicals and typically the secondary radical is favored. Such radicals add readily to conventional monomers such as (meth)acrylates, styrene, vinyl acetate, vinyl chloride, vinylidene fluoride, isoprene, and butadiene for example, and initiate the polymerization. In addition the Ti alkoxide which is formed at the same time, can initiate the living ring opening polymerization of cyclic esters. For simplicity, only one mode of epoxide radical ring opening is depicted in FIG. 1 for the grafted structures. The epoxide macroinitiator (3) typically contains a large excess of epoxide groups by comparison with available Cp₂TiCl and thus lead to its fast and complete consumption. Other living radical polymerization mediators such as CuX₂ (X=Cl, Br) are used to control grafting and prevent potential crosslinking. Thus, after the Ti-mediated radical ring opening initiation, CuX₂/bpy enables the synthesis of the graft copolymer (5) in a controlled fashion by reacting with additional monomer (2b) wherein R⁵ is hydrogen or C₁-C₆ alkyl, and R⁶ is C₁-C₆ alkyl, aryl, or C₁-C₆ alkylester. Radical ring opening is effected for only a portion of the available epoxides during grafting allowing for the sequential grafting copolymerization of several different grafting monomers (2c, 2d) until the complete consumption of all epoxides. For graft copolymers (6, 7), R⁷ and R⁹ are independently hydrogen or C₁-C₆ alkyl, and R⁸ and R¹⁰ are independently C₁-C₆ alkyl, aryl, or C₁-C₆ alkylester. The method described in FIG. 1 does not require additional epoxide protection/deprotection steps, as the amount of epoxide opening is controlled by the Cp₂TiCl/epoxide ratio and there is no reaction between Cu halides and epoxides.

In one embodiment, a method of preparing a graft copolymer comprises reacting a first grafting monomer with an epoxide macroinitiator in the presence of an early transition metal radical ring opening catalyst to form a first graft copolymer which comprises epoxide groups; reacting the first graft copolymer with a second grafting monomer in the presence of an early transition metal radical ring opening catalyst to form a second graft copolymer comprising two different grafts and remaining epoxide groups; reacting the second graft copolymer with a third grafting monomer in the presence of an early transition metal radical ring opening catalyst to form a third graft copolymer comprising three different grafts and optionally comprising remaining epoxide groups; and optionally reacting the third graft copolymer with a fourth grafting monomer in the presence of an early transition metal radical ring opening catalyst to form a fourth graft copolymer comprising four different grafts and optionally comprising remaining epoxide groups; and further reiterating the grafting reaction to obtain a graft copolymer comprising five, six, seven, eight, nine, ten, or more different grafts.

The graft copolymers can be used for a variety of applications, for example, as an additive to polymers or polymer blends to modify the physical/rheological properties (e.g., viscosity, modulus, elongation, barrier, etc., properties) of the resulting mixture or as a compatibilizer for a blend of polymers, specifically thermoplastics; adhesion promoters; paint and coating additive; detergent additive; elastomers; lubricant additive; hydrocarbon additive (e.g., engine oil) additive; and the like.

In an additional embodiment, the epoxide macroinitiator can be replaced with an aldehyde macroinitiator comprising pendent or main chain aldehyde groups, or a ketone macroinitiator comprising pendent or main chain ketone groups. The aldehyde and ketone groups can undergo a similar grafting process using the herein described early transition metal catalysts and the described grafting monomers. As with the epoxide macroinitiator, the grafting process can be iterative allowing for multiple grafts of varying structure. In one embodiment, the aldehyde or ketone macroinitiator is specifically a linear homopolymer or copolymer.

In one embodiment, a method of preparing a graft copolymer comprises reacting a first grafting monomer with an aldehyde or ketone macroinitiator in the presence of an early transition metal radical catalyst to form a first graft copolymer, wherein the first graft copolymer comprises aldehyde or ketone groups; reacting the first graft copolymer with a second grafting monomer in the presence of an early transition metal radical catalyst to form a second graft copolymer comprising two different grafts. The second graft copolymer can comprise unreacted aldehyde or ketone groups available for further grafting reactions. The second graft copolymer can be further reacted with a third grafting monomer in the presence of an early transition metal radical catalyst to form a third graft copolymer comprising three different grafts. In another embodiment, the second graft copolymer is further reacted two or more times with additional grafting monomers which are different from the first and second grafting monomer in the presence of an early transition metal radical catalyst to form a graft copolymer comprising three or more different grafts. The graft copolymer prepared from an aldehyde or ketone macroinitiator can undergo iterative grafting process to comprise three, four, five, six, seven, eight, nine, ten or more different grafts.

The early transition metal radical catalyst can be the same as the early transition metal radical ring opening catalysts described above. The grafting monomer can be any one of the ethylenically unsaturated group grafting monomer or cyclic grafting monomer described herein, or a combination comprising at least one of the foregoing grafting monomers.

As used herein, “alkyl” includes straight chain, branched, and cyclic saturated aliphatic hydrocarbon groups, having the specified number of carbon atoms, generally from 1 to about 12 carbon atoms for the straight chain and generally from 3 to about 12 carbon atoms for the branched and cyclic. Examples of alkyl include, but are not limited to, methyl, ethyl, n-propyl, isopropyl, n-butyl, 3-methylbutyl, t-butyl, n-pentyl, sec-pentyl, cyclopentyl, cyclohexyl, and octyl. Specific alkyl groups include lower allyl groups, those alkyl groups having from 1 to about 8 carbon atoms, from 1 to about 6 carbon atoms, or from 1 to about 4 carbons atoms.

As used herein “haloalkyl” indicates straight chain, branched, and cyclic alkyl groups having the specified number of carbon atoms, substituted with one or more halogen atoms, generally up to the maximum allowable number of halogen atoms (“perhalogenated”, e.g. perfluorinated). Examples of haloalkyl include, but are not limited to, trifluoromethyl, difluoromethyl, 2-fluoroethyl, and penta-fluoroethyl.

As used herein, “alkoxy” includes an alkyl group as defined above with the indicated number of carbon atoms attached through an oxygen bridge (—O—). Examples of alkoxy include, but are not limited to, methoxy, ethoxy, n-propoxy, i-propoxy, n-butoxy, 2-butoxy, t-butoxy, n-pentoxy, 2-pentoxy, 3-pentoxy, isopentoxy, neopentoxy, n-hexoxy, 2-hexoxy, 3-hexoxy, and 3-methylpentoxy.

“Haloalkoxy” indicates a haloalkyl group as defined above attached through an oxygen bridge.

As used herein, the term “aryl” indicates aromatic groups containing only carbon in the aromatic ring or rings. Such aromatic groups may be further substituted with carbon or non-carbon atoms or groups. Typical aryl groups contain 1 or 2 separate, fused, or pendant rings and from 6 to about 12 ring atoms, without heteroatoms as ring members. Where indicated aryl groups may be substituted. Such substitution may include fusion to a 5 to 7-membered saturated cyclic group that optionally contains 1 or 2 heteroatoms independently chosen from N, O, and S, to form, for example, a 3,4-methylenedioxy-phenyl group. Aryl groups include, for example, phenyl, naphthyl, including 1-naphthyl and 2-naphthyl, fluorene, and bi-phenyl.

“Halo” or “halogen” as used herein refers to fluoro, chloro, bromo, or iodo.

The term “alkylester” indicates an alkyl group as defined above attached through an ester linkage, i.e. a group of the formula —O(C═O)alkyl.

As used herein, “(meth)acrylate” is inclusive of both acrylate and methacrylate functional groups.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The following illustrative examples are provided to further describe the invention and are not intended to limit the scope of the claimed invention.

### EXAMPLES

Table 1 contains a list of reagents used in the following examples.

TABLE 1

| Reagent | Abbreviation | Source |
|---|---|---|
| Glycidyl methacrylate | GMA | Acros |
| Methyl methacrylate | MMA | Fisher |
| n-butyl methacrylate | BMA | Fluka |
| n-butyl acrylate | BA | Aldrich |
| Styrene | ST | Aldrich |
| ε-Caprolactone | CL | Acros |
| Bis(cyclopentadienyl)titanium dichloride | Cp₂TiCl₂ | Acros |
| Copper(I) chloride | CuCl | Acros |
| Copper(II) chloride | CuCl₂ | Acros |
| Copper(I) bromide | CuBr | Aldrich |
| Copper(II) bromide | CuBr₂ | Acros |
| 4-Methoxybenzenesulfonyl chloride | MBSC | Acros |
| Ethyl 2-bromoisobutyrate | EBIB | Acros |
| p-Toluenesulfonyl chloride | PTSCl | Acros |
| Zn powder (100 mesh) | Zn | Alfa Aesar |
| Diphenylether | Ph₂O | Alfa Aesar |
| 2,2′-Bipyridyl | bpy | Fluka |
| DL-3,6-dimethyl-1,4-dioxane-2,5-dione | (DL-Lactide | Purac America |

The prepared polymers were analyzed by proton nuclear magnetic resonance spectroscopy (¹H-NMR (500 MHz)) using a Bruker DRX-500 at 24° C. in CDCl₃ (Aldrich; 0.03% v/v TMS as internal standard). Gel permeation chromatography (GPC) analyses were performed at 34° C. on a Waters 150-C Plus gel permeation chromatograph equipped with a Waters 410 differential refractometer, a Waters 2487 dual wavelength absorbance UV-VIS detector set at 254 nm, a Polymer Laboratories PL-ELS 1000 evaporative light scattering (ELS) detector and with a Jordi Flash Gel 10⁵ Å, 2×10⁴ Å, and 1×10³ Å column setup. Tetrahydrofuran (THF) (99.9% HPLC grade, Fisher) was used as eluent at a flow rate of 3 mL/min. Number-average (Mₙ) and weight-average molecular weights (M_{w}) were determined from calibration plots constructed with polystyrene standards. Differential Scanning Calorimetry (DSC) was performed on a TA instruments (Q-100 series) DSC-2920 instrument. Typical sample sizes were between 10 and 15 mg. The samples were initially heated at 20° C./min to 150° C. and annealed for 2 min at this temperature to remove thermal history. The samples were then cooled to −10° C. (for PBA containing samples, to −80° C.) at 40° C./min and held there for 2 min, followed by a second heating at 20° C./min up to 150° C. Universal Analysis software (TA instruments, version 4.2 E, build 4.2.0.38) was used to calculate T_{g} from the second heating curve of all polymers.

### Example 1

### Preparation of Macroinitiator Polymers

Polyglycidylmethacrylate (PGMA): CuBr (43.0 mg, 0.30 mmol), bpy (141.0 mg, 0.90 mmol) and Ph₂O (4.0 mL) were added to a 25-mL Schlenk tube which was degassed by several freeze pump thaw cycles and was filled with Ar. GMA (4.0 mL, 30.11 mmol) and EBIB (44.2 μL, 0.30 mmol) were injected and the tube was re-degassed and heated at 40° C. for 2 hours. The polymer was precipitated into cold methanol, filtered and dried.

Polyglycidylmethacrylate-co-polymethylmethacrylate (PGMA-co-PMMA): CuCl (149.0 mg, 1.51 mmol), bpy (705.4 mg, 4.52 mmol) and Ph₂O (6.0 mL) were added to a 25-mL Schlenk tube which was degassed by several freeze pump thaw cycles and was filled with Ar. GMA (2.0 mL, 15.05 mmol), MMA (6.4 mL, 60.22 mmol) and MBSC (311.0 mg, 1.51 mmol) were injected and the tube was re-degassed and heated at 60° C. for 8 hours. The polymer was precipitated into cold methanol, filtered and dried.

Polyglycidylmethacrylate-co-polystyrene (PGMA-co-PSt) CuCl (35.5 mg, 0.35 mmol), bpy (168.0 mg, 1.07 mmol) and Ph₂O (4.0 mL) were added to a 25-mL Schlenk tube which was degassed by several freeze pump thaw cycles and was filled with Ar. GMA (2.0 mL, 15.05 mmol), St (2.4 mL, 20.79 mmol) and PTSCl (68.3 mg, 0.35 mmol) were injected and the tube was re-degassed and heated at 120° C. (performed at this temperature to prevent the formation of PGMA blocks) for 15 hours. The polymer was precipitated into cold methanol, filtered and dried.

### Example 2

### Preparation of Graft Copolymers by Grafting from Macroinitiator Polymers

Polyglycidylmethacrylate-g-polystyrene (PGMA-g-PSt): Cp₂TiCl₂ (17.5 mg. 0.07 mmol), Zn (2.5 mg, 0.04 mmol) and dioxane (1.0 mL) were added to a 25-mL Schlenk tube which was degassed by several freeze pump thaw cycles, filled with Ar, and the reduction was carried out at room temperature. The characteristic lime-green color of Ti(III) was observed in 10 mm. The tube was then cooled to −78° C. in an acetone/dry ice bath. A mixture of monomer (styrene, 0.8 mL, 7.03 mmol), macroinitiator (PGMA, Mn=16,300, PDI=1.15, 0.2 g in 1 mL of dioxane), CuBr₂ (15.7 mg, 0.07 mmol) and bpy (33.0 mg, 0.21 mmol) was added under Ar and the tube was re-degassed and heated at 90° C. in an oil bath. Samples were taken under Ar using an airtight syringe and were used for conversion and molecular weight determination by NMR and respectively by GPC. PGMA-g-PSt copolymer was precipitated into cold methanol, filtered and dried.

Polyglycidylmethacrylate-g-polymethylmethacrylate (PGMA-g-PMMA): Cp₂TiCl₂ (17.5 mg, 0.07 mmol), Zn (2.5 mg, 0.04 mmol) and dioxane (1.0 mL) were added to a 25-mL Schlenk tube which was degassed by several freeze pump thaw cycles, filled with Ar, and the reduction was carried out at room temperature. The characteristic lime-green color of Ti(III) was observed in 10 min. The tube was then cooled to −78° C. in an acetone/dry ice bath. A mixture of monomer (MMA, 0.8 mL, 7.03 mmol), macroinitiator (PGMA, Mn=6,400, PDI=1.12, 0.2 g in 1 mL of dioxane), CuBr₂ (15.7 mg., 0.07 mmol) and bpy (33.0 mg, 0.21 mmol) was added under Ar and the tube was re-degassed and heated at 90° C. Samples were taken under Ar using an airtight syringe and were used for conversion and molecular weight determination by NMR and respectively by GPC. PGMA-g-PMMA was precipitated into cold methanol, filtered and dried.

Polyglycidylmethacrylate-g-polybutylmethacrylate (PGMA-g-PBMA): Cp₂TiCl₂ (6.3 mg, 0.02 mmol), Zn (0.8 mg, 0.01 mmol) and dioxane (1.0 mL) were added to a 25-mL Schlenk tube which was degassed by several freeze pump thaw cycles, filled with Ar, and the reduction was carried out at room temperature. The characteristic lime-green color of Ti(III) was observed in 10 min. The tube was then cooled to −78° C. in an acetone/dry ice bath. A mixture of monomer (BMA, 0.4 mL. 2.53 mmol), macroinitiator (PGMA, Mn=6,400, PDI=1.12, 0.2 g in 1 mL of dioxane), CuCl₂ (3.4 mg, 0.02 mmol) and bpy (9.9 mg, 0.06 mmol) was added under Ar and the tube was re-degassed and heated at 90° C. The copolymer was precipitated into cold methanol, filtered and dried.

(Polyglycidylmethacrylate-co-polymethylmethacrylate)-g-polystyrene ((PGMA-co-PMMA)-g-PSt): Cp₂TiCl₂ (23.9 mg, 0.09 mmol), Zn (3.2 mg, 0.05 mmol) and dioxane (1.0 mL) were added to a 25-mL Schlenk tube which was degassed by several freeze pump thaw cycles, filled with Ar, and the reduction was carried out at room temperature. The characteristic lime-green color of Ti(III) was observed in 10 min. The tube was then cooled to −78° C. in an acetone/dry ice bath. A mixture of monomer (St, 1.1 mL, 9.63 mmol), macroinitiator (PGMA-co-PMMA, Mn=5,800, PDI=1.11, PGMA/PMMA=20/80, 0.2 g in 1 mL of dioxane), CuBr₂ (21.5 mg, 0.09 mmol) and bpy (45.1 mg. 0.28 mmol) was added under Ar and the tube was re-degassed and heated at 90° C. in an oil bath. Samples were taken under Ar using an airtight syringe and used for conversion and molecular weight determination by NMR and respectively by GPC. (PGMA-co-PMMA)-g-PSt was precipitated into cold methanol, filtered and dried.

(Polyglycidylmethacrylate-co-polymethylmethacrylate)-g-polybutylacrylate ((PGMA-co-PMMA)-g-PBA): Cp₂TiCl₂ (9.8 mg, 0.04 mmol), Zn (1.4 mg, 0.02 mmol) and dioxane (0.5 mL) were added to a 25-mL Schlenk tube which was degassed by several freeze pump thaw cycles, filled with Ar, and the reduction was carried out at room temperature. The characteristic lime-green color of Ti(III) was observed in 10 min. The tube was then cooled to −78° C. in an acetone/dry ice bath. A mixture of monomer (BA, 0.2 mL, 1.98 mmol), macroinitiator (PGMA-co-PMMA, Mn=5,500, PDI=1.14, PGMA/PMMA=2/98, 0.2 g in 1 mL of dioxane), CuBr₂ (17.6 mg, 0.08 mmol) and bpy (37.1 mg, 0.24 mmol) was added under Ar and the tube was re-degassed and heated at 90° C. in an oil bath. (PGMA-co-PMMA)-g-PBA was precipitated into cold methanol, filtered and dried.

(Polyglycidylmethacrylate-co-polystyrene)-g-polymethylmethacrylate ((PGMA-co-PSt)-g-PMMA): Cp₂TiCl₂ (15.1 mg, 0.06 mmol), Zn (2.0 mg, 0.03 mmol) and anisole (1.0 mL) were added to a 25-mL Schlenk tube which was degassed by several freeze pump thaw cycles, filled with Ar, and the reduction was carried out at room temperature. The characteristic lime-green color of Ti(III) was observed in 10 min. The tube was then cooled to 78° C. in an acetone/dry ice bath. A mixture of monomer (MMA, 0.5 mL, 4.57 mmol), macroinitiator (PGMA-co-PSt, Mn=24,674, PDI=1.34, PGMA/PSt=46/54, 0.3 g in 1 mL of anisole), CuCl₂ (8.2 mg, 0.06 mmol) and bpy (23.8 mg., 0.15 mmol) was added under Ar and the tube was re-degassed and heated at 75° C. in an oil bath. (PGMA-co-PSt)-g-PMMA was precipitated into cold methanol, filtered and dried.

### Example 3

### Sequential Graft Copolymerizations

(Polyglycidylmethacrylate-g-polymethylmethacrylate)-g-polystyrene ((PGMA-g-PMMA)-g-PSt): Cp₂TiCl₂ (2.4 mg, 0.009 mmol), Zn (0.3 mg, 0.005 mmol) and dioxane (0.5 mL) were added to a 25-mL Schlenk tube which was degassed by several freeze pump thaw cycles, filled with Ar, and the reduction was carried out at room temperature. The characteristic lime-green color of Ti(III) was observed in 10 min. The tube was then cooled to −78° C. in an acetone/dry ice bath. A mixture of monomer (styrene, 0.5 mL, 4.86 mmol), macroinitiator (PGMA-g-PMMA, Mn=39,868, PDI=1.41, PGMA/PMMA=10/90, 84% unopened PGMA epoxide, 0.2 g in 1 mL of dioxane), CuBr₂ (2.2 mg, 0.009 mmol) and bpy (4.6 mg, 0.03 mmol) was added under Ar and the tube was redegassed and heated at 90° C. in an oil bath. (PGMA-g-PMMA)-g-PSt was precipitated into cold methanol, filtered and dried.

(Polyglycidylmethacrylate-g-polystyrene)-g-polymethylmethacrylate ((PGMA-g-PSt)-g-PMMA): Cp₂TiCl₂ (3.4 mg, 0.013 mmol), Zn (0.5 mg, 0.007 mmol) and dioxane (0.5 mL) were added to a 25-mL Schlenk tube which was degassed by several freeze pump thaw cycles, filled with Ar, and the reduction was carried out at room temperature. The characteristic lime-green color of Ti(III) was observed in 10 min. The tube was then cooled to −78° C. in an acetone/dry ice bath. A mixture of monomer (MMA, 0.7 mL, 6.81 mmol), macroinitiator (PGMA-g-PSt, Mn=83,000, PDI=1.57, PGMA/PSt=8/92, 83% unopened PGMA epoxide, 0.4 g in 1.5 mL of dioxane), CuBr₂ (3.0 mg, 0.013 mmol) and bpy (6.4 mg, 0.04 mmol) was added under Ar and the tube was re-degassed and heated at 90° C. in an oil bath. (PGMA-g-PSt)-g-PMMA was precipitated into cold methanol, filtered and dried.

((Polyglycidylmethacrylate-g-polymethylmethacrylate)-g-polystyrene)-g-polybutylmethacrylate (((PGMA-g-PMMA)-g-PSt)-g-PBMA): Cp₂TiCl₂ (9.0 mg, 0.03 mmol), Zn (2.3 mg, 0.03 mmol) and dioxane (0.5 mL) were added to a 25-mL Schlenk tube which was degassed by several freeze pump thaw cycles, filled with Ar, and the reduction was carried out at room temperature. The characteristic lime-green color of Ti(III) was observed in 10 min. The tube was then cooled to −78° C. in an acetone/dry ice bath. A mixture of monomer (BMA, 1.1 mL, 7.27 mmol), macroinitiator ((PGMA-g-PMMA)-g-PSt, Mn=49,502, PDI=1.43, PGMA/PMMA/PSt=6/53/36, 63% unopened PGMA epoxide. 0.1 g in 1.0 mL of dioxane), CuBr₂ (8.1 mg, 0.03 mmol) and bpy (17.0 mg, 0.11 mmol) was added under Ar and the tube was re-degassed and heated at 90° C. in an oil bath. ((PGMA-g-PMMA)-g-PSt)-g-PBMA was precipitated into cold methanol, filtered and dried.

### Example 4

### Graft Copolymer Hydrolysis

0.05 g of polymer (PGMA-g-PSt, PGMA/PSt=20/80, Mn=46,500; PDI=1.49) was dissolved in 10 mL of THF in a 50 mL Schlenk tube. 10 drops of concentrated sulfuric acid was added into it and the mixture was refluxed at 100° C. for 7 days. The solvent was removed under vacuum, and the remaining solid was dissolved in a mixture of water and CH₂Cl₂. The organic layer was extracted three times from water, combined and dried over MgSO4. The solution was then concentrated and precipitated in methanol. The solid polymer was dried under vacuum overnight and characterized by ¹H NMR and GPC.

The characterization of graft copolymers derived from PGMA is summarized in Table 2. As indicated in the table, based on Cp₂TiCl/epoxide ratios about 20% of the epoxide groups were opened. This indicates a graft density of about one chain at every five GMA units and a graft length of about 4 to 140 units. The graft length increases with the grafting monomer/GMA ratio and conversion. However, since the polymerizations were stopped at different conversions, the molecular weight increase upon grafting does not scale directly with the initial monomer/GMA ratio. Thus, the experiments in Table 2 are listed according to the final copolymer composition. Hydrolysis of the side chain GMA ester linkage in the graft copolymers was used to further confirm the grafting process. Thus, acid catalyzed hydrolysis of PGMA-g-PSt (Mn=46,500, Mw/Mn=1.49; Table 2, exp 4) produces poly(methacrylic acid) and diol terminated polystyrene (Mn=2,000; Mw/Mn=1.15). NMR analysis also enables determination of the average graft length and regioselectivity of the epoxide radical ring opening. It was found that the epoxide ring opens predominantly with the formation of the more stable secondary vs. primary radical by a 75/25 ratio.

TABLE 2
Cp₂TiCl/CuBr₂ Catalyzed Graft Copolymerization of St, MMA and BMA from PGMA

| | | | | | | | PGMA | | PGMA-g-PM₁ | | |
|---|---|---|---|---|---|---|---|---|---|---|---|
| | | GMA/ | T | t | M₁ | RRO | Mₙ | T_{g} | Mₙ | PGMA/ | T_{g} |
| Exp | M₁ | M₁^{a} | ° C. | h | conv.^{b} | %^{b} | M_{w}/Mₙ | ° C. | M_{w}/Mₙ | PM₁^{b} | ° C. |
| 1 | St | 100/125 | 80 | 72 | 57 | 19 | 11,700 | 66 | 17,300 | 58/42 | 77 |
| | | | | | | | 1.16 | | 1.70 | | 104 |
| 2 | St | 100/500 | 90 | 6 | 26 | 22 | 16,300 | 72 | 31,100 | 40/60 | 76 |
| | | | | | | | 1.15 | | 1.66 | | 104 |
| 3 | St | 100/500 | 80 | 70 | 60 | 25 | 16,300 | 72 | 44,600 | 29/71 | 77 |
| | | | | | | | 1.15 | | 1.56 | | 105 |
| 4 | St | 100/500 | 90 | 18 | 53 | 22 | 16,300 | 72 | 46,500 | 20/80 | 104 |
| | | | | | | | 1.15 | | 1.49 | | |
| 5 | St | 100/2000 | 80 | 23 | 47 | 17 | 6400 | 55 | 83,000 | 8/92 | 106 |
| | | | | | | | 1.12 | | 1.57 | | |
| 6 | St | 100/375 | 90 | 46 | 71 | 13 | 16,300 | 72 | 41,400 | 5/95 | 106 |
| | | | | | | | 1.15 | | 1.65 | | |
| 7 | MMA | 100/150 | 60 | 25 | 49 | 27 | 13,800 | 65 | 24,701 | 45/55 | 84 |
| | | | | | | | 1.10 | | 1.32 | | 118 |
| 8 | MMA | 100/500 | 90 | 4 | 91 | 16 | 6400 | 55 | 39,868 | 10/90 | 114 |
| | | | | | | | 1.12 | | 1.40 | | |
| 9 | BMA | 100/200 | 90 | 22 | 88 | 21 | 6400 | 55 | 58,073 | 15/85 | 30 |
| | | | | | | | 1.12 | | 1.34 | | 76 |

^{a}Calculated as GMA/M₁ monomer mole ratio; [PGMA]/[Cp₂TiCl₂]/[Zn]/[CuBr₂]/[bpy] = 100/5/2.75/5/15 (Exp #9, [PGMA]/[Cp₂TiCl₂]/[Zn]/[CuCl₂]/[bpy] = 100/2/1/2/5).
^{b}Determined by ¹H NMR

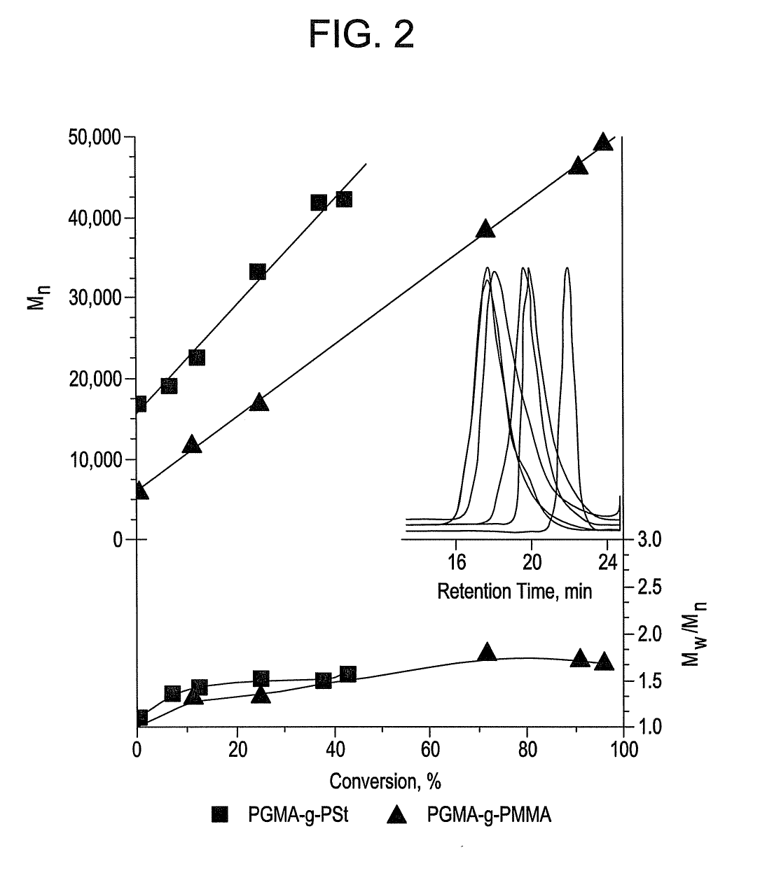

GPC traces of PGMA graft copolymers exhibited a monomodal increase in molecular weight from the parent PGMA. While Mₙ is measured vs. linear PSt standards and is thus approximate, GPC in conjunction with the NMR results, supports the formation of graft copolymers. Moreover, the use of CuBr₂/bpy enables control of the polymerization by reverse ATRP, and grafting occurs in a controlled fashion for both St and MMA as shown in FIG. 2. Accordingly, the graft copolymer molecular weight increases linearly with conversion and maintains a reasonable polydispersity of about 1.5-1.7 for PGMA-g-PSt and 1.3-1.5 for PGMA-g-PMMA and PGMA-g-PBMA.

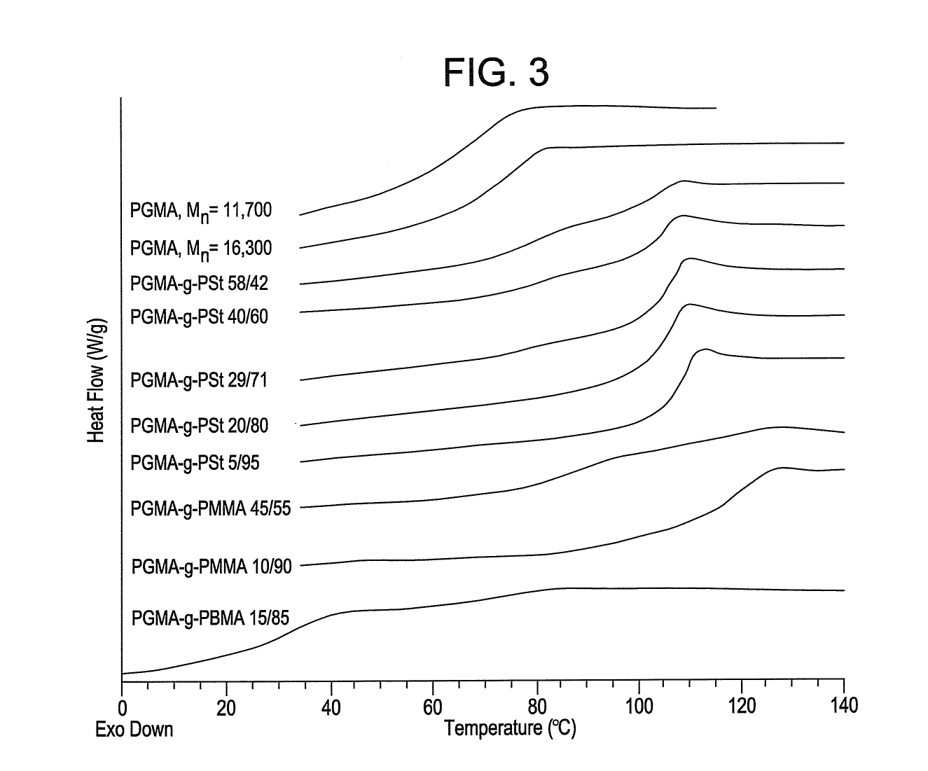

The formation of graft copolymers is also supported by the DSC thermal characterization (FIG. 3). PGMA-g-PSt copolymers with GMA/St=58/42 and 40/60 display two glass transitions, as expected for immiscible systems. T_{g}^{PGMA} increases slightly from about 66-72° C. to about 77° C. whereas T_{g}^{PSt}=104° C. This is a consequence of the graft connectivity, which reduces the number of free PSt chain ends and restricts the PGMA backbone mobility while providing bulky PSt side groups. A minor shoulder is observed for the GMA/St=29/71 copolymer at 77° C., while T_{g}^{PGMA} was not evident in copolymers with over 80% styrene. Two different T_{g} values were also detected for PGMA-g-PMMA with a 45/55 composition. While alkyl methacrylates are typically miscible, this effect may be due to the larger polarity of the epoxide ring of the glycidyl group of GMA by comparison to the CH₃ unit of MMA (e.g. μ=1.89 D for ethylene oxide and μ˜0 D for CH₄). Nonetheless, at higher MMA content (90%), a single glass transition, T_{g}=118° C. is observed. PGMA-g-PBMA (15/85) displays a lower T_{g} at ˜30° C. which corresponds to the PBMA graft and a higher T_{g} at 76° C. associated with PGMA.

The characterization of PGMA-co-PMMA and PGMA-co-PSt linear macroinitiators and of the corresponding (PGMA-co-PMMA)-g-PSt, (PGMA-co-PMMA)g-PBA and (PGMA-co-PSt)-g-PMMA graft copolymers is summarized in Table 3. A comparison of the 500 MHz ¹H-NMR spectra of the linear and grafted structures permits the evaluation of composition, % epoxide ring opening and graft length.

TABLE 3
Cp₂TiCl/CuBr₂ Catalyzed Graft Copolymerization of St, BA and MMA from PGMA-co-PMMA and PGMA-co-PSt.

| | | | | | | M₂ | | PGMA-co-Pm₁ | | (PGMA-co-PM₁)-g-PM₂ | | |
|---|---|---|---|---|---|---|---|---|---|---|---|---|
| | | | GMA/M₁/M₂/Cp₂TiCl₂/ | T | t | Conv. | RRO | Mₙ | T_{g} | Mₙ | GMA/ | T_{g} |
| Exp | M₁ | M₂ | Zn/CuBr₂/bpy | ° C. | h | %^{a} | %^{a} | M_{w}/Mₙ | ° C. | M_{w}/Mₙ | M₁/M₂^{a} | ° C. |
| 1 | MMA | St | 20/80/525/5/2.75/5/15 | 80 | 9 | 25 | 38 | 5,800 | 95 | 10,406 | 15/55/30 | 107 |
| | | | | | | | | 1.11 | | 1.55 | | |
| 2 | MMA | St | 20/80/525/21/10/21/63 | 80 | 9 | 20 | 82 | 5,800 | 95 | 11,472 | 19/72/9 | 113 |
| | | | | | | | | 1.11 | | 1.42 | | |
| 3 | MMA | St | 2/98/200/4/8/0/0 | 90 | 7 | 54 | 100 | 5,346 | 106 | 17,407 | 0.8/41/58.2 | 101 |
| | | | | | | | | 1.12 | | 2.33 | | 116 |
| 4 | MMA | St | 2/98/400/4/8/0/0 | 90 | 46 | 62 | 100 | 5,698 | 106 | 13,532 | 0.5/21/78.5 | 99 |
| | | | | | | | | 1.06 | | 2.82 | | 115 |
| 5 | MMA | St | 2/98/200/6/12/0/0 | 75 | 20 | 77 | 100 | 5,698 | 106 | 9,051 | 0.5/27/72.5 | 97 |
| | | | | | | | | 1.06 | | 1.39 | | 117 |
| 6 | MMA | BA | 2/98/100/2/1/4/12 | 90 | 10 | 23 | 100 | 5,500 | 106 | 8,900 | 1.8/91/7.2 | 106 |
| | | | | | | | | 1.14 | | 1.07 | | |
| 7 | MMA | BA | 20/80/500 | 90 | 22 | 72 | 100 | 5,800 | 95 | 21,518 | 8.5/34/57.5 | −47 |
| | | | 20/11/0/0 | | | | | 1.11 | | 2.18 | | 104 |
| 8 | MMA | BA | 20/80/500 | 90 | 14 | 20 | 100 | 5,800 | 95 | 14,165 | 4.3/17.2/78.5 | −47 |
| | | | 20/10/20/60 | | | | | 1.11 | | 1.34 | | 101 |
| 9 | MMA | BA | 20/80/4000 | 90 | 24 | 96 | 100 | 5,800 | 95 | 83,409 | 1.7/7.3/91 | −48 |
| | | | 20/11/0/0 | | | | | 1.11 | | 1.99 | | 108 |
| 10^{b} | St | MMA | 46/54/187/2.5/1.3/2.5/6.3 | 75 | 18 | 67 | 17 | 24,674 | 76 | 42,121 | 25/30/45 | 98 |
| | | | | | | | | 1.34 | | 1.70 | | |
| 11^{b} | St | MMA | 46/54/250/2.5/1.3/2.5/6.3 | 90 | 19 | 85 | 22 | 24,674 | 76 | 54,121 | 15/17/68 | 108 |
| | | | | | | | | 1.34 | | 1.67 | | |

^{a}Determined by ¹H NMR.
^{b}CuCl₂ was used instead of CuBr₂ in exp #10 and 11.

Two PGMA-co-PMMA compositions (20/80 and 2/98) were synthesized and used in the grafting of St and BA. The 20/80 copolymer provides an average graft density of about one grafted chain for every ˜6 and respectively ˜12 main chain repeat units, corresponding to ˜80% and respectively ˜40% epoxide radical ring opening. The larger amount of epoxide radical ring opening also allows for a slightly narrower molecular weight distribution of the graft copolymer, corresponding to shorter grafted chains. The low epoxide content in the 2/98 copolymer enables the radical ring opening of all epoxide groups. The control of the grafting was also attempted in the absence of CuBr₂ by using an excess of Cp₂TiCl (exp 3-5). Thus, while broad distributions (M_{w}/Mₙ=2.3-2.8) are observed at 90° C., decreasing the temperature to 75° C. and increasing the Ti/epoxide ratio decreases the polydispersity to about 1.4, which is similar to the results obtained in the presence of CuBr₂ and consistent with the temperature and stoichiometry effects on Ti catalyzed styrene polymerizations. However, narrower polydispersities are obtained for BA grafting in the presence of CuBr₂ (exp 6, 8). PGMA-co-PSt with GMA/St=46/54 was also used as a macroinitiator for the CuCl₂ assisted graft copolymerization of MMA at 75-90° C. to generate (PGMA-co-PSt)-g-PMMA of two different compositions.

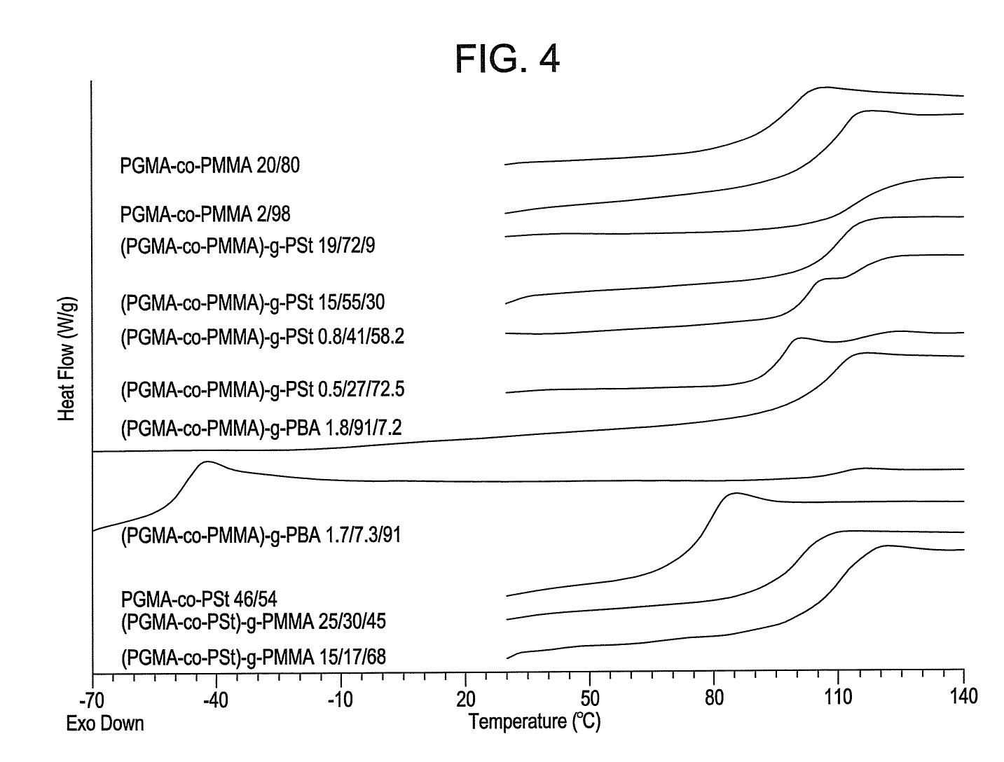

DSC characterization (FIG. 4) provides further evidence of grafting. Thus, while T_{g}^{PGMA-co-PMMA (20/80)}=95° C., at low (<30 mol %) styrene content, a single T_{g}=107-113° C. is seen for (PGMA-co-PMMA)-g-PSt. By comparison, T_{g}^{PGMA-co-PMMA (2/98)}=106° C. and phase separation emerges for PSt>50 mole %, as evidenced by the bimodality of the transition, with T_{g}^{PGMA-co-PMMA} increasing to about 116° C. and T_{g}^{PSt}=97-101° C. However, grafting of BA up to 7 mol % does not generate a detectable change in T_{g}^{(PGMA-co-PMMA)-g-PBA} vs. T_{g}^{PGMA-co-PMMA (2/98)}. By contrast, while T_{g}^{PGMA-co-PMMA 20/80}=95° C., graft copolymers containing 60-90 mol % PBA display a clear transition associated with T_{g}^{PBA}˜−45° C., while the glass transition of the main chain increases as seen before to T_{g}^{PGMA-co-PMMA}=104-108° C. The glass transition of PGMA-co-PSt increases upon PMMA grafting from T_{g}^{PGMA-co-PSt (46/54)}=76° C. to T_{g}^{(PGMA-co-Pst)-g-PMMA}=98° C. and respectively 108° C. with increasing MMA content from 45% to 68%. Since PGMA-co-PSt is a random copolymer as demonstrated by NMR, no phase separation is expected in this case.

Several examples of sequential grafting are outlined below and summarized in Table 4. Again characterization was provided by NMR, GPC and DSC. Both PGMA-g-PMMA and PGMA-g-PSt synthesized as described above still contain about 80% of the original unopened PGMA epoxides, which are available for further grafting. Consequently, a fraction of the remaining epoxides were opened by Cp₂TiCl to a cumulative 40% radical ring opening vs. the original PGMA. The corresponding radicals were used in the initiation of the CuBr₂-mediated grafting copolymerization of St and MMA to generate (PGMA-g-PMMA)-g-PSt and respectively (PGMA-g-PSt)-g-PMMA. These miktoarm graft copolymers still contain about 60% of the original epoxides which can conceivably be used for further initiation. Therefore, all the remaining unopened epoxides of (PGMA-g-PMMA)-g-PSt were used in the sequential grafting of the third monomer, BMA to generate ((PGMA-g-PMMA)-g-PSt)-g-PBMA.

TABLE 4
Cp₂TiCl/CuBr2 Catalyzed Sequential Grafting from PGMA

| | | (Macro) | M/I/Cp₂TiCl₂/ | t | % | % | | Compo- | Mₙ | Tg |
|---|---|---|---|---|---|---|---|---|---|---|
| Ex | M | Initiator | Zn/CuBr₂/bpy^{a} | h | conv.^{c} | RRO^{c} | Polymer | sition^{c} | M_{w}/Mₙ | ° C. |
| 1 | GMA | MBSC | b | 2 | 94 | 0 | PGMA | 100 | 6,400 | 55 |
| | | | | | | | | | 1.12 | |
| 2 | MMA | PGMA | 500/100/5/2.75/5/15 | 4 | 91 | 16 | PGMA-g- | 10/90 | 39,868 | 114 |
| | | | | | | | PMMA | | 1.41 | |
| 3 | St | PGMA | 2000/100/5/2.75/5/15 | 23 | 47 | 17 | PGMA-g- | 8/92 | 83,000 | 106 |
| | | | | | | | PSt | | 1.57 | |
| 4 | St | PGMA-g- | 250/(10/90)/0.5/0.25/0.5/1.5 | 19 | 16 | 37 | (PGMA-g- | 6/58/36 | 49,502 | 92 |
| | | PMMA | | | | | PMMA)-g- | | 1.43 | 115 |
| | | | | | | | PSt | | | |
| 5 | MMA | PGMA-g- | 176/(8/92)/0.35/0.2/0.3/1 | 24 | 35 | 38 | (PGMA-g- | 5/68/27 | 102,967 | 105 |
| | | PSt | | | | | PSt)-g- | | 1.48 | 126 |
| | | | | | | | PMMA | | | |
| 6 | BMA | (PGMA-g- | 378/(6/58/36)/3.8/3.8/3.8/11.3 | 21 | 96 | 100 | ((PGMA-g- | 1.8/8.6/11.4/68.2 | 132,537 | 34 |
| | | PMMA)- | | | | | PMMA)-g- | | 1.79 | 106 |
| | | g-Pst | | | | | PSt)-g- | | | |
| | | | | | | | PBMA | | | |
| 7 | BMA | (PGMA-g- | 756/(6/58/36)/3.8/3.8/3.8/11.3 | 42 | 100 | 100 | ((PGMA-g- | 1/10/6.4/82.6 | 245,161 | 36, |
| | | PMMA)- | | | | | PMMA)-g- | | 2.09 | 108 |
| | | g-PSt | | | | | PSt)-g- | | | |
| | | | | | | | PBMA | | | |

^{a}Molar concentration, all reaction at 90° C. (except Exp #1 at 40° C. and Exp #3 at 80° C.).
^{b}GMA/MBSC/CuCl/bpy 50/1/1/3.
^{c}Determined by ¹H NMR.

The sequential grafting is again demonstrated (Table 4) by the continuous and monomodal molecular weight increase at each iteration. Thus, Mₙ^{PGMA}=6,400; Mₙ^{PMA-g-PMMA}=39,868; Mₙ^{(PGMA-g-PMMA)-g-PSt}=49,502 while Mₙ^{PGMA-g-PSt}=83,000; Mₙ^{(PGMA-g-PSt)-g-PMMA}=102.96 and finally Mₙ^{((PGMA-g-Pmma)-g-PSt)-g-PBMA}=132,537 or 245,161. The NMR spectra also confirm the presence of the second (St) and respectively third (BMA) sequentially grafted monomers.

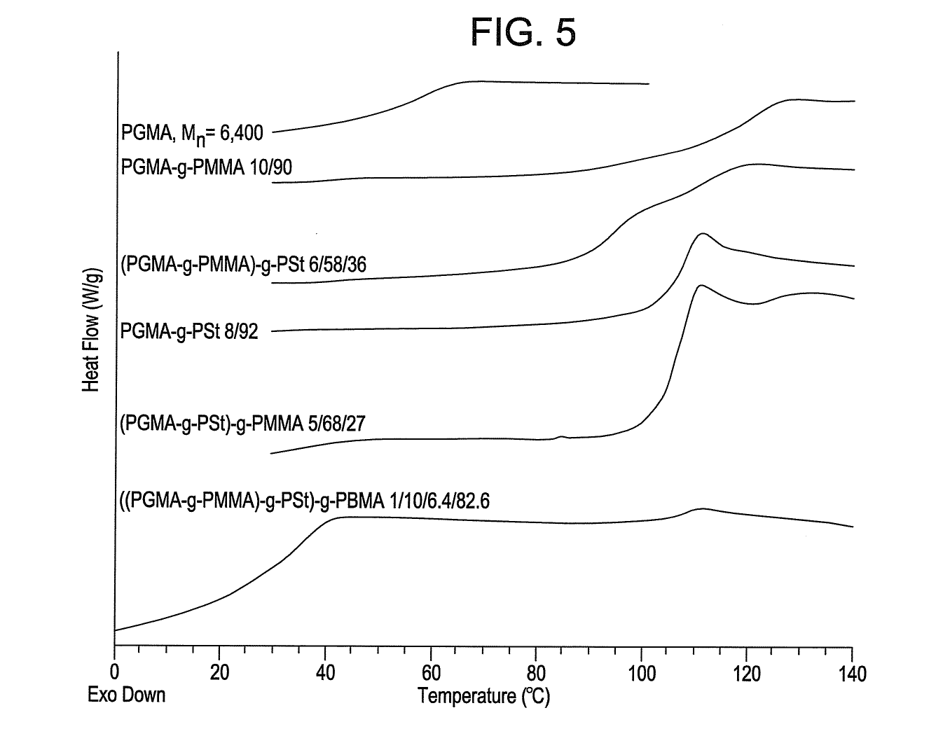

The thermal characterization is presented in FIG. 5. After the first iteration, the glass transition increases from T_{g}^{PGMA}=55° C. to T_{g}^{PGMA-g-PMMA (10/90)}=114° C. and respectively T_{g}^{PGMA-g-PSt(8/92)}=106° C. Upon the sequential grafting of PSt onto PGMA-g-PMMA, phase separation occurs and consequently, two transitions are observed for (PGMA-g-PMMA)-g-PSt (6/58/36) at 92° C. and respectively 115° C. However, upon sequential grafting of PMMA onto PGMA-g-PSt, T_{g}^{(PGMA-g-PSt)-g-PMMA (5/68/27)} remains relatively unchanged at 106° C., most likely due to the overriding effect of the larger St content and the higher molecular weight by comparison with the complementary experiment. A weak transition is also observed at 126° C. and is probably associated with the stiffening of the main chain of PGMA. After the third iteration, upon grafting of PBMA onto (PGMA-g-PMMA)-g-PSt, the resulting ((PGMA-gPMMA)-g-PSt)-g-PBMA displays a lower T_{g} associated with PBMA at 34° C. and a higher transition corresponding to the PSt and PMMA chains at 108° C.

### Example 5

Synthesis of linear PMMA-co-PGMA: CuCl (37.2 mg, 0.38 mmol), 2,2′-bipyridyl (176.3 mg, 1.13 mmol) and Ph₂O (2.0 mL) were added to a 25-mL Schlenk tube containing a stir bar. The tube was degassed by several freeze pump thaw cycles and filled with Ar. GMA (0.5 mL, 3.76 mmol), MMA (1.61 mL, 15.05 mmol) and 4-methoxybenzenesulfonyl chloride (77.7 mg, 0.38 mmol) were added via syringe and the tube was re-degassed and was heated at 60° C. in an oil bath for 2 hours. The polymer was precipitated into cold methanol, filtered and dried under vacuum.

### Example 6

### Graft Copolymerization, Cyclic Grafting Monomers

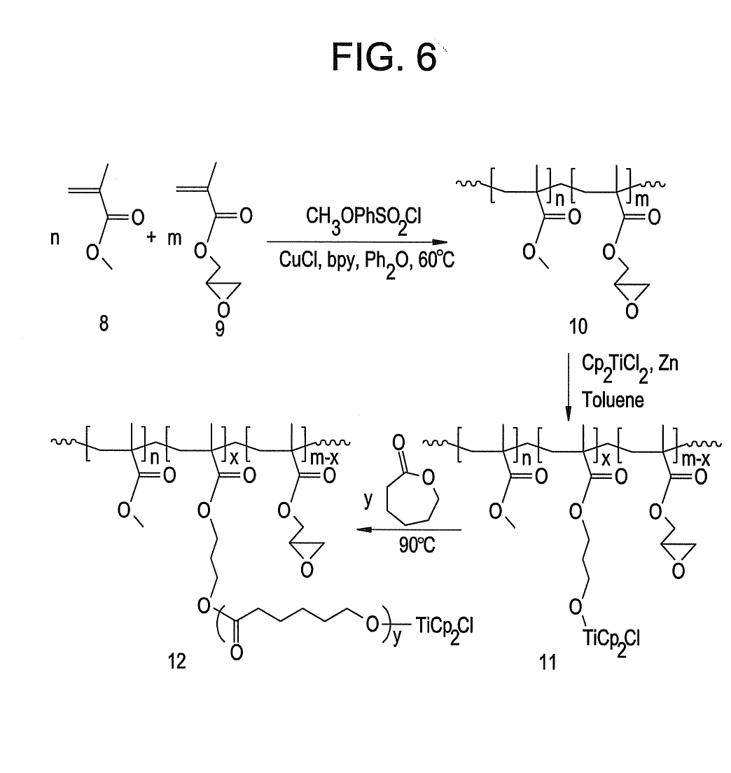

Synthesis of (PGMA-co-PMMA)-g-PCL. Cp₂TiCl₂ (9.87 mg, 0.04 mmol), Zn (1.42 mg, 0.02 mmol) and ε-caprolactone (0.22 mL, 1.98 mmol) were added to a 25-mL Schlenk tube containing a stirbar. The tube was degassed by several freeze pump thaw cycles, filled with Ar, and the reduction was carried out at rt for 5-10 mins. The tube was then cooled to −78° C. in an acetone/dry ice bath. The macroinitiator of Example 5 (PMMA-co-PGMA), Mn=5,569, PDI=1.10,) 0.2 g in 1 mL toluene,) was injected through the side arm and the tube was re-degassed and heated at 90° C. for 2 h. The polymer was precipitated into hexane, filtered and dried under vacuum. A generalized schematic of the CL grafting process is provided in FIG. 6.

Synthesis of (PGMA-co-PMMA)-g-PLA. Cp₂TiCl₂ (13.56 mg, 0.05 mmol), Zn (1.78 mg, 0.03 mmol), 0.5 mL toluene and 0.5 mL dioxane were added to a 25-mL Schlenk tube containing a stir bar. The tube was degassed by several freeze pump thaw cycles, filled with Ar, and the reduction was carried out at rt for 5-10 mins. The tube was then cooled to −78° C. in an acetone/dry ice bath. The monomer (DL-Lactide (0.78 g, 5.44 mmol)) and the macroinitiator of Example 5 ((PMMA-co-PGMA), Mn=5,569, PDI=1.10, 0.2 g) were added under argon and the tube was re-degassed and heated at 90° C. for 2 h. The polymer was precipitated into hexane, filtered and dried under vacuum.

(PGMA-co-PMMA)-g-PCL and (PGMA-co-PMMA)-g-PLA were analyzed by 500 MHz ¹H-NMR and GPC. GPC analysis were performed at 34° C. on a Waters 150-C Plus gel permeation chromatograph equipped with a Waters 410 differential refractometer, a Waters 2487 dual wavelength absorbance UV-VIS detector set at 254 nm, a Polymer Laboratories PL-ELS 1000 evaporative light scattering (ELS) detector and with a Jordi Gel DVB 10⁵ Å, a PL Gel 10⁴ Å, a Jordi Gel DVB 100 Å, and a Waters Ultrastyragel 500 Å column setup. THF (Fisher; 99.9% HPLC grade) was used as eluent at a flow rate of 3 mL/min. Number-average (Mₙ) and weight-average molecular weights (M_{w}) were determined from calibration plots constructed with polystyrene standards. Results are provided in Table 5. The GPC results for the grafting of the PMMA-co-PGMA with DL-lactide indicates a monomodal increase in Mn from 5,500 to 13,640 in conjunction with relatively low Mw/Mn values.

TABLE 5
Grafting of CL and LA from PMMA-co-PGMA

| | Monomer | [M]:[I]^{a)}: | | | |
|---|---|---|---|---|---|
| Ex. | (M) | [Ti]:[Zn] | Mn | PDI | Composition |
| 1 | CL | 600:100:6:3.3 | 10,260 | 1.34 | PMMA:PGMA:PCL |
| | | | | | 56:18:26 |
| 2 | LA | 600:100:6:3 | 13,640 | 1.21 | PMMA:PGMA:PLA |
| | | | | | 23:7:70 |

^{a)}PMMA-co-PGMA, Mn = 5,300, PDI = 1.10, PMMA:PGMA = 76:24

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All ranges disclosed herein are inclusive and combinable. The terms “first,” “second,” and the like, “primary,” “secondary,” and the like, as used herein do not denote any order, quantity, or importance, but rather are used to distinguish one element from another. “Optional” or “optionally” means that the subsequently described event or circumstance may or may not occur, and that the description includes instances where the event occurs and instances where it does not.

The essential characteristics of the present invention are described completely in the foregoing disclosure. One skilled in the art can understand the invention and make various modifications without departing from the basic spirit of the invention, and without deviating from the scope and equivalents of the claims, which follow. Moreover, any combination of the above-described elements in all possible variations thereof is encompassed by the invention unless otherwise indicated herein or otherwise clearly contradicted by context.

What is claimed is:

1. A method of preparing a graft copolymer, comprising:
reacting a first grafting monomer with an epoxide macroinitiator in the presence of an early transition metal radical ring opening catalyst to form a first graft copolymer, wherein the first graft copolymer comprises epoxide groups;
reacting the first graft copolymer with a second grafting monomer in the presence of an early transition metal radical ring opening catalyst to form a second graft copolymer comprising two different grafts;
wherein the second graft copolymer optionally comprises remaining unreacted epoxide groups available for further grafting reactions.

2. The method of claim 1, wherein the second graft copolymer is further reacted with a third grafting monomer in the presence of an early transition metal radical ring opening catalyst to form a third graft copolymer comprising three different grafts.

3. The method of claim 1, wherein the second graft copolymer is further reacted two or more times with additional grafting monomers which are different from the first and second grafting monomer in the presence of an early transition metal radical ring opening catalyst to form a graft copolymer comprising three, four, five, six, seven, eight, nine, ten or more different grafts.

4. The method of claim 1, wherein the early transition metal radical ring opening catalyst is one having the general structure L₂MY,
wherein M is Ti, Zr, Hf, or Cr;
each occurrence of L is independently a cyclopentadienyl; alkylsubstituted cyclopentadienyl substituted with one or more C₁-C₄ alkyl groups; indenyl; a C₁-C₄ alkoxy group; an ansa ligand; halogen; and
Y is fluoro, chloro, bromo or iodo.

5. The method of claim 1, wherein the early transition metal radical ring opening catalyst is bis(cyclopentadienyl)titanium chloride, bis(cyclopentadienyl)zirconium chloride, or bis(cyclopentadienyl)hafnium chloride.

6. The method of claim 1, wherein the epoxide macroinitiator is a polymer comprising pendent or main chain epoxide groups prepared by
i) epoxidation of unsaturated polymers;
ii) derivatization of a polymer backbone with epichlorohydrin; or
iii) polymerization of a macroinitiator monomer comprising both an ethylenically unsaturated group and an epoxide group, optionally in the presence of an additional monomer comprising an ethylenically unsaturated group.

7. The method of claim 6, wherein the macroinitiator monomer is one that meets the general structure G-Z-E,
wherein G is acrylate (CH₂═CH—(C═O)O—), thioacrylate (CH₂═CH—(C═O)S—), C₁-C₄ alkyl(acrylate), C₁-C₄ thioalkyl(acrylate), vinyl, methylvinyl, fluorovinyl, allyl, acrylamide, or C₁-C₄ alkyl(acrylamide);
Z is a divalent C₁-C₆ alkyl, aryl, C₁-C₆ alkylaryl, aryl(C₁-C₆)alkyl, or C₁-C₆ alkylaryl(C₁-C₆)alkyl; and
E is an epoxide group.

8. The method of claim 6, wherein the macroinitiator monomer is glycidyl acrylate, glycidyl methacrylate, glycidyl acrylamide, glycidyl methacrylamide, 1,2-epoxy-p-menth-8-ene (limonene oxide), 4-vinyl-1-cyclohexene 1,2-epoxide, or a combination comprising at least one of the foregoing monomers.

9. The method of claim 6, wherein the additional monomer is one that meets the general structure G¹-R^{a},
wherein G¹ is acrylate (CH₂═CH—(C═O)O—), thioacrylate (CH₂═CH—(C═O)S—), C₁-C₄ alkyl(acrylate), C₁-C₄ thioalkyl(acrylate), vinyl, methylvinyl, allyl, acrylamide, or C₁-C₄ alkyl(acrylamide); and
R^{a} is C₁-C₆ alkyl, aryl, —C₁-C₆ alkylaryl, -aryl(C₁-C₆)alkyl, —C₁-C₆ alkylaryl(C₁-C₆)alkyl, halogen, —O(C═O)C₁-C₆ alkyl, or —CH═CH₂.

10. The method of claim 6, wherein the additional monomer is methyl acrylate, methyl methacrylate, ethyl acrylate, ethyl methacrylate, n-propyl acrylate, n-propyl methacrylate, isopropyl acrylate, isopropyl methacylate, n-butyl acrylate, n-butyl methacrylate, iso-butyl acrylate, iso-butyl methacrylate, tert-butyl acrylate, tert-butyl methacrylate, benzyl acrylate, benzyl methacrylate, phenyl acrylate, phenyl methacrylate, styrene, alpha-methylstyrene, vinyltoluene, ethylvinylbenzene, acrylonitrile, vinyl acetate, a vinyl ester, vinyl chloride, vinyl fluoride, vinylidene fluoride, isoprene, butadiene, or a combination comprising at least one of the foregoing monomers.

11. The method of claim 1, wherein each grafting monomer is independently a monomer comprising an ethylenically unsaturated group, a cyclic monomer, or a combination comprising at least one of the foregoing grafting monomers.

12. The method of claim 11, wherein each grafting monomer independently meets the general structure G²-R^{b},
wherein G² is acrylate (CH₂═CH—(C═O)O—), thioacrylate (CH₂═CH—(C═O)S—), C₁-C₄ alkyl(acrylate), C₁-C₄ thioalkyl(acrylate), vinyl, methylvinyl, allyl, acrylamide, or C₁-C₄ alkyl(acrylamide); and
R^{b} is C₁-C₆ alkyl, aryl, —C₁-C₆ alkylaryl, -aryl(C₁-C₆)alkyl, —C₁-C₆ alkylaryl(C₁-C₆)allyl, —Si(OC₁-C₆ alkyl)₃, halogen, —O(C═O)C₁-C₆ alkyl, or —CH═CH₂.

13. The method of claim 11, wherein each grafting monomer independently is methyl acrylate, methyl methacrylate, ethyl acrylate, ethyl methacrylate, n-propyl acrylate, n-propyl methacrylate, isopropyl acrylate, isopropyl methacylate, n-butyl acrylate, n-butyl methacrylate, iso-butyl acrylate, iso-butyl methacrylate, tert-butyl acrylate, tert-butyl methacrylate, benzyl acrylate, benzyl methacrylate, phenyl acrylate, phenyl methacrylate, styrene, vinyltoluene, ethylvinylbenzene, acrylonitrile, vinyl acetate, a vinyl ester, vinyl chloride, vinyl fluoride, vinylidene fluoride, isoprene, butadiene, β-propiolactone, γ-butyrolactone, δ-valerolactone, ε-caprolactone, 3-methyl-1,4-dioxane-2,5-dione, 3,6-dimethyl-1,4-dioxane-2,5-dione (lactide), 1,4-dioxane-2,5-dione (glycolide), p-dioxanone, 2-azacyclopentanone, 2-azacyclohexanone, ε-caprolactam, 2-azacyclooctanone, 2-azacyclononanone, N-acylated derivatives thereof, or a combination comprising at least one of the foregoing monomers.

14. The method of claim 11, wherein each grafting monomer is independently a C₃-C₁₂ cyclic monoester, a C₃-C₁₂ cyclic diester, a C₃-C₁₂ cyclic monoamide, a C₃-C₁₂ cyclic diamide, or a combination comprising at least one of the foregoing grafting monomers.

15. The method of claim 11, wherein two or more different grafting monomers are grafted in a single grafting reaction iteration, wherein one of the grafting monomers is a monomer comprising an ethylenically unsaturated group; and
wherein one of the grafting monomers is a cyclic monomer.

16. The method of claim 15, wherein the monomer comprising an ethylenically unsaturated group is methyl acrylate, methyl methacrylate, ethyl acrylate, ethyl methacrylate, n-propyl acrylate, n-propyl methacrylate, isopropyl acrylate, isopropyl methacylate, n-butyl acrylate, n-butyl methacrylate, iso-butyl acrylate, iso-butyl methacrylate, tert-butyl acrylate, tert-butyl methacrylate, benzyl acrylate, benzyl methacrylate, phenyl acrylate, phenyl methacrylate, styrene, vinyltoluene, ethylvinylbenzene, acrylonitrile, vinyl acetate, a vinyl ester, vinyl chloride, vinyl fluoride, vinylidene fluoride, isoprene, butadiene, or a combination comprising at least one of the foregoing monomers; and
wherein the cyclic monomer is β-propiolactone, γ-butyrolactone, δ-valerolactone, ε-caprolactone, 3-methyl-1,4-dioxane-2,5-dione, 3,6-dimethyl-1,4-dioxane-2,5-dione (lactide), 1,4-dioxane-2,5-dione (glycolide), p-dioxanone; or 2-azacyclopentanone, 2-azacyclohexanone, ε-caprolactam, 2-azacyclooctanone, 2-azacyclononanone, N-acylated derivatives thereof; or a combination comprising at least one of the foregoing grafting monomers.

17. The method of claim 1, wherein the reacting is further performed in the presence of an additional catalyst comprising an atom transfer radical polymerization catalyst; a nitroxide; or a reversible addition-fragmentation catalyst.

18. The method of claim 17, wherein the additional catalyst is a thioester, or a copper(II)halide catalyst comprising a C₁-C₆ allyl amine, an arylamine, or a phosphine ligand.

19. A graft copolymer comprising three, four, five, six, seven, eight, nine, ten or more different grafts.

20. The graft copolymer of claim 19, wherein each graft is independently methyl acrylate, methyl methacrylate, ethyl acrylate, ethyl methacrylate, n-propyl acrylate, n-propyl methacrylate, isopropyl acrylate, isopropyl methacylate, n-butyl acrylate, n-butyl methacrylate, iso-butyl acrylate, iso-butyl methacrylate, tert-butyl acrylate, tert-butyl methacrylate, benzyl acrylate, benzyl methacrylate, phenyl acrylate, phenyl methacrylate, styrene, vinyltoluene, ethylvinylbenzene, acrylonitrile, vinyl acetate, a vinyl ester, vinyl chloride, vinyl fluoride, vinylidene fluoride, isoprene, butadiene, β-propiolactone, γ-butyrolactone, δ-valerolactone, ε-caprolactone, 3-methyl-1,4-dioxane-2,5-dione, 3,6-dimethyl-1,4-dioxane-2,5-dione (lactide), 1,4-dioxane-2,5-dione (glycolide), p-dioxanone; or 2-azacyclopentanone, 2-azacyclohexanone, ε-caprolactam, 2-azacyclooctanone, 2-azacyclononanone, or N-acylated derivatives thereof.
